(19) United States
(12) Patent Application Publication
(10) Pub. No.: US 2008/0003455 A1
(43) Pub. Date: Jan. 3, 2008

(54) Organic El Device

(75) Inventors: Chong Li, Matsumoto City (JP); Hiroshi Kimura, Matsumoto City (JP); Koji Kawaguchi, Matsumoto City (JP); Yutaka Terao, Matsumoto City (JP); Toshio Hama, Matsumoto City (JP)

Correspondence Address: ROSSI, KIMMS & McDOWELL LLP., P.O. BOX 826, ASHBURN, VA, 20146-0826, US

(73) Assignee: FUJI ELECTRIC HOLDINGS CO., LTD., Kawasaki-ku, Kawasaki (JP)

(21) Appl. No.: 11/721,272

(22) PCT Filed: Oct. 20, 2005
(86) PCT No.: PCT/JP05/19273

§ 371 Date: Jul. 25, 2007

(30) Foreign Application Priority Data
Dec. 8, 2004 (JP) 2004-355917

(51) Int. Cl. B32B 9/00; H01J 1/63

(52) U.S. Cl. 428/690; 313/504

(57) ABSTRACT

A white organic EL element structure exhibiting a good emission efficiency in which the emission color does not vary with current application time. The organic EL element has an organic EL layer sandwiched by a pair of electrodes, characterized in that wherein the organic EL layer includes at least a carrier recombination layer and one or more of carrier nonrecombination layers the carrier recombination layer emits blue or blue green EL light having a peak wavelength of 400-500 nm through recombination of carriers injected into the organic EL element, the carrier nonrecombination layer contains a host material having carrier injection/transportation ability and absorbing at least a part of the EL light and one or more of kinds of PL emission dye material emitting PL light of lower energy than that of the EL light, and the distance between the carrier recombination layer and the carrier nonrecombination layer is 15 nm or above.

### TECHNICAL FIELD

The present invention relates to an organic EL device that emits white light or light blue light. The organic EL devices can be used in back lights of color liquid crystal displays and other illuminating devices and displays.

### BACKGROUND ART

FIG. 5 is a schematic sectional view of an example of a white light organic EL device of a prior art. The white light organic EL device 50 of a prior art comprises a hole injection layer 3, a hole transport layer 4, a light emitting layer 55, an electron transport layer 6, and an electron injection layer 7 sequentially formed on a glass substrate 1 with an anode 2 formed thereon, and further a cathode 8 formed on the electron injection layer 7. The light emitting layer 55, which functions as a carrier recombination center, of the conventional white light organic EL device 50 is either a single light emitting layer containing a mixture of plural types of light emitting dyes, or a laminate of plural layers containing plural types of different light emitting dyes.

In the conventional white light organic EL device 50, carriers are injected from the cathode 8 and the anode 2. The negative carriers (electrons) and the positive carriers (holes), in an appropriate balance, recombine in the light emitting layer 55 and excite the plural types of light emitting dye materials contained in the light emitting layer 55 at the same time, to give white light from the substrate surface. (Non-patent Documents 1 and 2, and Patent Documents 1 and 2.)

Organic EL devices working through this light emission mechanism hardly achieve a simple white light organic EL device exhibiting high efficiency and long life. A white EL device (Patent Document 3) composed of a single light emitting layer containing plural types of mixed light emitting dye materials (light emitting dopants), for example, emits light through the following processes from generation of carriers until emission of white light: (1) movement of carriers (electrons and holes) to a carrier recombination layer, (2) generation of excitons of host light emitting materials, (3) transfer of excited energy between molecules of the host light emitting materials, (4) transfer of excitation energy from the host light emitting materials to a guest light emitting material, (5) generation of excitons of the guest light emitting material, (6) energy transfer between different types of guest light emitting materials, and (7) relaxation of the excitons of guest light emitting material to the ground state.

Each of the energy transfer processes (3) through (6) is a competitive process with various kinds of energy deactivation process. To obtain pure white EL emission in this structure, the process (6), an energy transfer process between different types of guest light emitting materials, is a critical process.

If the doping concentration of these light emitting dye materials is not optimized, energy transfer happens from a dye material with large excitation energy to a dye material with small excitation energy, hardly giving pure white light. The concentrations of red light emitting dopant and blue light emitting dopant that are required for exhibiting good electroluminescent characteristics are extremely small values of 0.12% and 0.25%, respectively, of the host material. Control of such concentrations is very difficult in mass production. Even if the emitted light is initially pure white light, the emission color often changes depending on magnitude and period of current supply. This shift of color is caused by disturbed balance of energy transfer between the light emitting dye materials in the light emitting layer (carrier recombination layer) 55.

In a white light organic EL device composed of different types of light emitting layers, the carriers are injected from the electrodes and recombined in the plurality of light emitting layers, and the plural types of light emitting dye materials are excited simultaneously to obtain white organic EL emission from the surface of the device.

A white light organic EL device of this structure needs proper balance between recombinations of carriers in the plurality of light emitting layers. In many cases, carrier recombination area varies depending on the driving voltage of the device. Light emission from one dye material is enhanced and light emission from another dye material is diminished, shifting the color of light emission from the substrate surface.

Recently, a white EL device was disclosed from Eastman Kodak Company, USA (Patent Documents 4 and 5). The carrier recombination region of the organic EL device is adjusted to locate at the interface between a light emitting layer and a carrier transport layer. The carrier recombination center is at the interface between the blue light emitting layer and the carrier transport layer doped with yellow light emitting dopant. In this interface region, the blue light emitting material is excited and a part of the excited energy is transferred to the adjacent yellow light emitting layer (carrier transport layer), which also emits light. As a result, the device emits white light with a mixed spectrum in a blue range and a yellow range from the substrate surface.

In the above mentioned prior art, the carrier recombination center is at the interface between the blue light emitting layer and the yellow dye-doped electron transport layer. The carrier recombination area grows wider by the larger driving current. The energy from the blue light emitting layer is transferred to the yellow dye-doped carrier transport layer. The blue light and yellow light from these layers are mixed to give white light from the surface of the device. A white light emitting organic EL device in this type of light emission mechanism was disclosed in Extended Abstract of the Meeting of the Japan Society of Applied Physics and Related Societies in 1997 (Non-patent Document 3).

Another white light emitting organic EL device was proposed (Patent Document 6), which comprises a blue light emitting layer adjacent to a hole transport layer and, next to the blue light emitting layer, a green light emitting layer that includes a region of red fluorescent layer. Yet another white light emitting organic EL device was proposed (Non-patent Document 4), which comprises red, blue and green light emitting layers separated from each other by a hole blocking layer.

Patent Document 7 has proposed an organic light emitting device comprising a light emitting layer and a hole injection-transport layer, in which the hole injection-transport layer is composed of a doping layer containing a fluorescent dopant and a non-doping layer containing no fluorescent dopant, that is disposed at an interface with the light emitting layer and has a thickness at least 2 nm. This structure allows energy transfer from the light emitting layer material to the fluorescent dopant while avoiding non-radiative deactivation of the fluorescent dopant due to exciplex formation or carrier transportation.

In the mechanism for obtaining white light from a device surface in every invention of the prior art mentioned above, the excitons generated by carrier recombination directly make one or more types of dye materials emit light. (In the case the recombination region is localized around an organic interface region, two types of dye materials in the layers adjacent to the interface are simultaneously excited upon application of a voltage.) Alternatively, energy is transferred from blue light emitting excitons with high emission energy to a dye material with low emission energy located within the potential radius of the exciton to make the dye material of low emission energy emit light, giving white light from the device surface. In other words, these mechanisms perform multicolor emission through simultaneous energy excitation of plural types of dye materials or energy transfer between plural types of dye materials.

In the method of light emission through energy transfer between different materials, a potential radius of an ionized molecule, which is a distance required for the energy transfer, is theoretically at most 15 nm. Consequently, the energy transfer can be theoretically supposed to be effectively performed when the thickness of the light emitting layer of high emission energy and the thickness of the adjacent light emitting layer of low emission energy are within 15 nm from the interface of the two layers.

In recent years, a color conversion method (CCM) has been studied as one of the methods for achieving multicolor or full color display using organic EL devices. The method uses a color conversion layer containing a color conversion material that absorbs near ultraviolet light, blue light, blue-green light, or white light emitted from the organic EL device and emits light in the visible light range through wavelength distribution conversion. The color conversion method increases the freedom of selection of light sources because the color of the emitting light of the light source is not limited to white light. Using an organic EL device that emits blue or blue-green color light, for example, green and red color light can be obtained through the wavelength distribution conversion. In addition to the method of combining an organic EL device with a color conversion layer provided on a separate substrate, a type of organic EL device performing color conversion function within the device has been recently proposed (Patent Documents 8 and 9, for example), which is provided with a layer performing color conversion in addition to a light emitting layer.

Patent Document 1: Japanese Patent No. 2991450

Patent Document 2: Japanese Unexamined Patent Application Publication No. 2000-243563

Patent Document 3: U.S. Pat. No. 5,683,823

Patent Document 4: Japanese Unexamined Patent Application Publication No. 2002-93583

Patent Document 5: Japanese Unexamined Patent Application Publication No. 2003-86380

Patent Document 6: Japanese Unexamined Patent Application Publication No. H7-142169

Patent Document 7: Japanese Unexamined Patent Application Publication No. H6-215874

Patent Document 8: Japanese Unexamined Patent Application Publication No. H6-203963

Patent Document 9: Japanese Unexamined Patent Application Publication No. 2001-279238

Patent Document 10: Japanese Unexamined Patent Application Publication No. 2004-115441

Patent Document 11: Japanese Unexamined Patent Application Publication No. 2003-212875

Patent Document 12: Japanese Unexamined Patent Application Publication No. 2003-238516

Patent Document 13: Japanese Unexamined Patent Application Publication No. 2003-81924

Patent Document 14: WO 2003/048268

Patent Document 15: Japanese Patent No. 2772019

Non-patent Document 1: J. Kido et al., Science 267, 1332 (1995)

Non-patent Document 2: J. Kido et al., Appl. Phys. Lett., 67(16) 2281-2283 (1995)

Non-patent Document 3: Endo et al, Extended Abstract of the 44th Meeting of the Japan Society of Applied Physics and Related Societies, No. 29p-NK-1, 1151 (1997) (in Japanese)

Non-patent Document 4: Deshpande et al., Appl. Phys. Lett., 75, 888 (1999)

### DISCLOSURE OF INVENTION

An object of the present invention is to provide a white light or light blue light emitting organic EL device that exhibits little change in emission efficiency, allows application of manufacturing processes for conventional organic EL devices, and hardly changes emitting color depending on operation time or magnitude of supplied current.

A material to be used in an organic EL device performing color conversion function within the device faces strict requirements that the material satisfies the following conditions at the same time: the material does not obstruct the movement of carriers (electrons or holes) to the light emitting layer; the material does not cause nonradiative deactivation such as exciplex formation with the EL emission material in the carrier recombination layer (light emitting layer); and the material converts the light generated in the light emitting layer to light in the desired wavelength range in high efficiency. Accordingly, a more specific object of the present invention is to provide an organic EL device having a structure that alleviates these conditions and expands a range of material selection.

An organic EL device of the invention comprises an organic EL layer sandwiched by a pair of electrodes, the organic EL layer including at least a carrier recombination layer and one or more carrier nonrecombination layers; the carrier recombination layer emits EL light in blue to blue-green color having a peak wavelength from 400 to 500 nm through recombination of the carriers injected into the organic EL device; the carrier nonrecombination layer has carrier injection/transport property and contains a host material that absorbs at least a part of the EL light and one or more types of PL light emitting dye material that emits PL light with lower energy than that of the EL light; and a distance between the carrier recombination layer and the carrier nonrecombination layer is at least 15 nm. The carrier nonrecombination layer can be a hole injection layer, an electron injection layer, or a hole injection-transport layer. The organic EL device can be designed to emit a part of the EL light not absorbed by the host material and the PL light that can be yellow light or red light, eventually emitting white light. The PL light emitting dye material can be one type of material. The pair of electrodes is an anode and a cathode. The organic EL layer can further include a non-emissive hole injection layer that is in contact with the anode and contains a hole injectivity enhancing agent. The cathode can be made of a material having a work function of not larger than 4.3 eV and a light reflectivity of at least 90%. The cathode can be formed of a transparent conductive material and the anode can have a light reflectivity of at least 80%.

In an organic EL device having the structure described above, blue light emission through EL (electroluminescence) that needs carrier recombination takes place only in the light emitting layer and the light in other colors is emitted through PL (photoluminescence) by absorbing a part of this blue light emission. In the case of a light emitting layer doped with plural types of EL emitting dyes as in the prior art, energy transfer occurs between those dyes and blue light emission with higher energy is hindered. In contrast, such energy transfer does not take place in an organic EL device of the invention in which a distance between a carrier recombination layer and the carrier nonrecombination layer is set in at least 15 nm, and thus, emission efficiency is not lowered by bearing a part of the color conversion function by the host material in the layer (carrier nonrecombination layer) containing a fluorescent dopant.

Since a specified PL light emitting dye material gives a constant quantum yield for absorption of a specified excitation light (EL light), the emission intensity of the PL emission dye material varies in proportion to intensity of the EL emission. Therefore, emission spectrum of an organic EL device of the invention scarcely varies with variation of driving voltage and current, and desired white light or light blue light is stably emitted. Even if the intensity of the EL light from the light emitting layer changes with the elapse of operation time of the organic EL device, the intensity of PL emission also changes following the change of the EL light. Consequently, desired white light or light blue light is stably emitted in this case, too.

### BRIEF DESCRIPTION OF DRAWINGS

FIG. 1 is a schematic sectional view showing an organic EL device of first embodiment according to the invention;

FIG. 2 is a schematic sectional view showing an organic EL device of second embodiment according to the invention;

FIG. 3 is a schematic sectional view showing an organic EL device of third embodiment according to the invention;

FIG. 4 is a schematic sectional view showing an organic EL device of fourth embodiment according to the invention;

FIG. 5 is a schematic sectional view showing an organic EL device of a prior art;

FIG. 6 shows schematic structure of a PL light emissive carrier nonrecombination layer according to the invention; and

FIG. 7 shows an example of schematic structure comprising a plurality of PL light emissive carrier non-recombination layers according to the invention.

### BEST MODE FOR CARRYING OUT THE INVENTION

An organic EL device of the invention comprises a light emitting layer (carrier recombination layer) and a carrier nonrecombination layer, the latter is composed of a host material that can absorb the light from the light emitting layer and is doped with a PL light emitting dye material(s) (yellow PL light emitting dye material or a red PL light emitting dye material). The distance between the light emitting layer and the carrier nonrecombination layer is at least 15 nm. In an organic EL device of the invention, the carriers injected by the applied voltage emit blue to blue-green light with a peak wavelength from 400 nm to 550 nm through electroluminescence (EL) in the light emitting layer. The host material in the carrier nonrecombination layer absorbs a part of the EL light and the energy absorbed by the host material is transferred to a PL light emitting dye material, which emits yellow light or red light with lower energy (with a wavelength in the range of 550 nm to 750 nm). The two types of light, PL emission and EL emission light, are mixed and transmit through the substrate surface simultaneously. The irradiated light is seen as light blue light or white light. In short, a feature of the organic EL device of the invention is to obtain multicolor light by emitting light from the PL emitting dye material with lower emission energy utilizing light as transmission medium within the organic EL device.

Different from the prior art technology, a PL light emitting dye material contained in the carrier nonrecombination layer in the invention is separated with a distance of at least 15 nm from the light emitting layer (which emits blue to blue-green color EL light), and emits PL light with lower energy (longer wavelength) through EL light absorption in the host material not relying on energy transfer from excitons in the carrier recombination layer. An organic EL device having this structure exhibits the characteristic that the emitting spectrum hardly changes due to the change in driving voltage and current. This is caused by the fact that a quantum yield of light produced by a specified excitation light (EL light) is constant in a specified PL light emitting dye material, and the intensity of light emission from the PL light emitting dye material varies in proportion to intensity of the EL light emission. Therefore, when the intensity of EL light emission is changed, the intensity of PL light emission changes in proportion to the EL emission.

A carrier nonrecombination layer in the organic EL device of the invention is any one of a hole injection layer, an electron injection layer, a hole injection-transport layer that performs both functions of hole injection and hole transport, and an electron injection-transport layer that performs both functions of electron injection and electron transport. A carrier nonrecombination layer in the invention is preferably separated from a carrier recombination layer with a distance at least 15 nm in order to avoid nonradiative deactivation of the PL light emitting dye material due to exciplex formation with the EL light emitting material in the carrier recombination layer (light emitting layer) or carrier transfer from the EL light emitting material. Considering suppression of driving voltage, the distance between the carrier recombination layer and the carrier nonrecombination layer is preferably in the range of 15 to 50 nm, more preferably in the range of 15 to 30 nm.

A carrier nonrecombination layer of the invention can be composed of (a) a host material that absorbs EL light, which is blue to blue-green color light, and has a property of carrier (hole or electron) injection/transport, and (b) one or more types of PL light emitting dye materials that receive energy of the host material that has absorbed the EL light, and emit light in the wavelength range of 550 nm to 750 nm.

FIG. 6 shows an example of a structure of the carrier nonrecombination layer 70 comprising a host material 71 and two types of PL light emitting dye materials 72 and 73. The host material 71 has a higher excitation energy than the two types of PL light emitting dye materials 72 and 73, that is, the host material exhibits absorption in shorter wavelength. In the example of FIG. 6, excitation energy of the materials is assumed in the order of, from the highest to the lowest, the host material 71, the PL light emitting dye material 72, and the PL light emitting dye material 73. A part of the EL light 75 from the light emitting layer is absorbed by the host material 71 having the highest excitation energy and excites the host material 71. Energy transfer occurs from the excited host material 71 to the PL light emitting dye material 72 through any processes such as dipole-dipole interaction (Forster model) and PL light emission-reabsorption. The PL light emitting dye material 72 may emit PL light 76, or energy transfer may occur from the PL light emitting dye material 72 to the PL light emitting dye material 73, which in turn emits PL light emission 77. This structure increases the difference in peak emission wavelengths between the absorption peak wavelength of the host material 71 that absorbs the EL light at first and the peak emission wavelength of the PL light emitting dye material 72 or 73 that performs PL light emission finally. By virtue of this effect, selection range of the PL light emitting dye materials is extended. Although two types of PL light emitting dye materials are doped in this example, one or three or more PL light emitting dye materials can be used as well.

Amount of absorption of the EL light by the carrier nonrecombination layer can be controlled by regulating the thickness of the carrier nonrecombination layer in the invented device. The intensity of the PL light emitted from the carrier nonrecombination layer can be controlled by regulating the doping concentration of the PL light emitting dye material in the carrier nonrecombination layer in addition to the regulation of the amount of absorption of the EL light. Therefore, the color of the light emission obtained from the surface of the organic EL device can be easily tuned by regulating the proportion between the amount of the EL light passing through the carrier nonrecombination layer and intensity of the PL light.

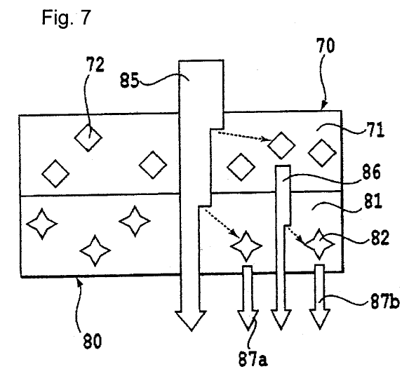

FIG. 7 shows an example of a structure employing a plurality of carrier nonrecombination layers (70 and 80). The host material 71 of the first carrier nonrecombination layer 70 has a higher excitation energy than the PL light emitting dye material 72, and the host material 81 of the second carrier nonrecombination layer 80 has a higher excitation energy than the PL light emitting dye material 82. In the structure of FIG. 7, a part of the EL light 85 from a light emitting layer is absorbed by the host material 71 of the first carrier nonrecombination layer 70 and excites the host material 71. Then, energy transfer occurs from the excited host material 71 to the PL light emitting dye material 72 through any processes such as dipole-dipole interaction (Forster model) and PL emission-reabsorption process, and the first PL emission 86 occurs. Then, a part of the EL light 85 and a part of the first PL emission 86 are absorbed by the host material 81 of the second carrier nonrecombination layer 80 and excites the host material 81. Energy transfer occurs from the excited host material 81 to the PL light emitting dye material 82 and the second PL emission 87(a, b) occurs. The multi-step structure using plural layers increases the difference in wavelength between the absorption peak wavelength of the host material 71 that absorbs EL light at first and the emission peak wavelength of the PL light emitting dye material 82 that emits PL light finally. This effect is advantageous for extending the selection range of the PL light emitting dye material as described previously.

The two layer structure of the carrier nonrecombination layers allows selection of optimum host material for each of the two types of PL light emitting dye materials 72 and 82, which is advantageous for enhancing efficiency of the organic EL device. Tuning of the spectrum of obtained light emission from the device can be more easily performed by varying light intensities of unabsorbed component of the EL light 85, and first and second PL emission 86 and 87(a, b), regulation of which can be carried out adjusting film thickness, doping concentration of the PL light emitting dye material, and types of host material and PL light emitting dye material in each of the carrier nonrecombination layers independently for each layer. Although the example includes two carrier nonrecombination layers each doped with one type of PL light emitting dye material, PL light emitting dye materials can be two or more in each layer, and the number of the carrier nonrecombination layers can be three or more.

In an organic EL device of the invention, the carrier nonrecombination layer that conducts color conversion through PL light emission locates inside the organic EL device. Consequently, the EL light enters the carrier nonrecombination portion avoiding the effect of total reflection at the interface with a transparent electrode, which has been one of the problems in the CCM method. Therefore, the EL light in blue to blue-green color can be more effectively converted to red color. In addition, conversion efficiency to red light can be freely adjusted without degrading current-voltage characteristic of an organic EL device.

Organic EL devices of the invention can be expected to be applied to backlights for monochromatic displays and to white back lights for full color organic EL displays employing the color filter method (using RGB color filters, for example).

Some preferred embodiments will be described in the following with reference to the accompanying drawings.

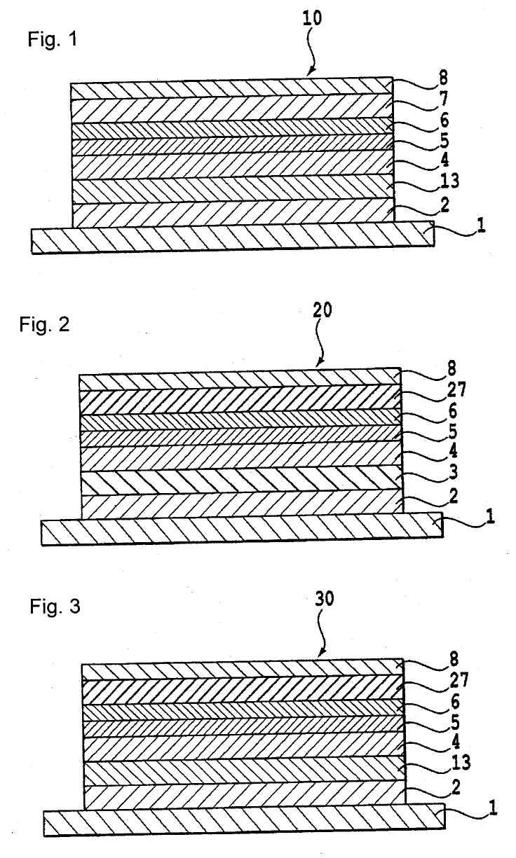

FIG. 1 is a sectional view of an organic EL device of a first embodiment according to the invention. An organic EL device 10 comprises an anode 2, an organic EL layer (including a PL light emissive hole injection layer 13, a hole transport layer 4, a light emitting layer 5, an electron transport layer 6, and an electron injection layer 7), and a cathode 8 sequentially laminated over a transparent substrate 1. Each of the anode 2 and cathode 8 can be transparent or reflective, while one of the two is desired transparent and the other is reflective.

The transparent substrate 1 is preferably transparent to the visible light (wavelength in the range from 400 to 700 nm). The transparent substrate needs to withstand the conditions in the processes for forming the upper layers over the substrate. Good dimensional stability is also desired. Useful materials for the transparent substrate 1 include quartz, glass plate, resin films and sheets of polyester, poly(methyl methacrylate), polycarbonate, polysulfone and the like.

Material of the anode 2 is selected from the materials having a large work function of at least 4.7 eV to reduce energy barrier in hole injection. The anode 2 can be transparent or reflective. In the case the light from the organic EL device is taken out from the side of transparent substrate 1, the anode 2 is desired to be transparent (exhibiting transmissivity of more than 80% to the visible light). A transparent anode 2 can be formed of a transparent conductive material generally known as a transparent electrode. Such materials are conductive inorganic compounds including for example, ITO (indium tin oxide), IZO (indium zinc oxide), SnO₂, ZnO₂, TiN, ZrN, HfN, TiOₓ, VOₓ, CuI, InN, GaN, CuAlO₂, CuGaO₂, SrCu₂O₂, LaB₆, and RuO₂. These materials are deposited on the transparent substrate 1 by means of a vacuum evaporation method or a sputtering method.

In case the light from the organic EL device is taken out from the side of cathode 8, the anode 2 is desired reflective. A reflective anode 2 has preferably a reflectivity at least 80% to the visible light. The anode can be formed by laminating one of the aforementioned transparent conductive materials, and a material selected from a high reflectivity metal, amorphous alloy, or microcrystalline alloy. Useful high reflectivity metals include Al, Ag, Mo, W, Ni, and Cr. Useful high reflectivity amorphous alloys include NiP, NiB, CrP, and CrB. Useful high reflectivity microcrystalline alloys include NiAl.

Material of the cathode 8 is primarily selected from materials with low work function of at most 4.3 eV to reduce energy barrier in electron injection. The cathode 8 can be transparent or reflective. In the case the light from the organic EL device is taken out from the side of transparent substrate 1, the cathode 8 is desired reflective (preferably reflectivity to the visible light of at least 90%). A reflective cathode 8 is formed of a material selected from alkali metals such as Li, Na, and K, alkaline earth metals such as Mg and Ca, and rare earth metals such as Eu, and alloy of these metals with Al, Ag, In and the like. The cathode material can be also selected from metals of Al, Zr, Ti, Y, Sc, and Si, and alloys containing these metals.

In case the light of an organic EL device is taken out from the side of cathode 8, the cathode 8 is desired transparent. A transparent cathode 8 can be formed using the aforementioned transparent conductive material.

When a cathode is made of a transparent conductive material, a buffer layer having electron injective property can be provided at the interface between the cathode and the organic EL layer to enhance electron injection efficiency. Useful materials for the buffer layer include alkali metals such as Li, Na, K and Cs, alkaline earth metals such as Ba and Sr, and alloy containing these metals, rare earth metals, and fluorides of these metals, though not limited to these materials. Thickness of the buffer layer can be appropriately set considering driving voltage and transparency, and is preferably at most 10 nm in normal cases.

A PL light emissive hole injection layer 13 can be composed of a) a host material that absorbs EL light, which is blue to blue-green color light, and has a property of carrier (hole or electron) injection/transport, and b) one or more types of PL light emitting dye materials that receive energy of the host material that has absorbed the EL light, and emit light in the wavelength range of 550 nm to 750 nm.

Host materials useful for the PL light emissive hole injection layer 13 in the invention include hole transport materials of high molecular weight perylene moiety such as BAPP, BABP, CzPP, and CzBP (Patent Document 10). The host material can also be selected from fluorescent materials having hole transport property including: aza-aromatic compounds having aza-fluoranthene skeleton bonded with arylamino group (Patent Document 11), condensed aromatic compounds having fluoranthene skeleton bonded with amino group (Patent Document 12), triphenylene aromatic compounds having amino group (Patent Document 13), and perylene aromatic compounds having amino group (Patent Document 4).

PL light emitting dye material that can be doped in the PL light emissive hole injection layer 13 is a PL light emitting dye material exhibiting high durability and emitting yellow to red color light, and can be selected from: dicyanine dyes such as 4-dicyanomethylene-2-methyl-6-(p-dimethylaminostyryl)-4H-pyran (DCM); pyridine material such as 1-ethyl-2-(4-(p-dimethylaminophenyl)-1,3-butadienyl)-pyridium-perchlorate (pyridine 1); xanthene material of rhodamine moiety; oxazine material; coumarin dyes exemplified in Patent Document 6; acridine dyes; and other condensed aromatic ring materials. Useful materials further includes recently developed materials for example, styryl compounds capable of yellow to red color light emission, diketopyrrolo[3,4-c]pyrrole derivative, benzimidazole compounds having condensed thiadiazole heterocyclic skeleton, porphyrin derivative compounds, quinacridone compounds, and bis(aminostyryl)naphthalene compounds. Other researched materials can be used such as naphthalimido derivative, thiadiazolopyridine derivative, pyrrolopyridine derivative, and naphthyridine derivative. Green fluorescent dyes of coumarin moiety can also be doped. Useful fluorescent materials in the invention are not limited by the state of the art in development in chemistry. Yet other useful materials include rare earth complex material exhibiting excellent emission color (Patent Document 15) and phosphorescent materials achieving highly efficient emission such as iridium complex and palladium complex.

The hole transport layer 4 in this embodiment defines the distance between the carrier recombination layer (light emitting layer) and the carrier nonrecombination layer (PL light emissive hole injection layer 13) and preferably has a thickness at least 15 nm. The hole transport layer 4 can be formed of a compound that can transport holes and can be readily formed to a thin film. A layer of those materials performs good hole transport effect as to transport holes smoothly and efficiently into the light emitting layer 5 and prevents electrons from moving into the hole transport layer 4. Specific materials include p type hydrogenated amorphous silicon, p type hydrogenated amorphous silicon carbide, p type zinc sulfide, and p type zinc selenide. These materials can be deposited by a dry deposition method such as a vacuum evaporation method, a CVD method, a plasma CVD method, or a sputtering method.

The hole transport layer can be formed using a known organic material selected from phenylamine polymer materials such as N,N-bis(3-methylphenyl)-(1,1′-biphenyl)-4,4′-diamine, N,N-diphenyl-N,N′-(3-methylphenyl)-1,1′-biphenyl-4,4′-diamine, 1,1-bis(4-di-p-tolylaminophenyl) cyclohexane, and 4,4′-bis(N-(1-naphtyl)-N-phenylamino)biphenyl; hydrazone compounds; silazane compounds; quinacridone compounds; and phthalocyanine derivatives (including metal-coordinated complex such as copper phthalocyanine). These materials can be deposited on a substrate by a usual vacuum evaporation method. Polymers of poly(vinyl carbazole), polysilane and the like can be used for a material of a hole injection layer, too. A layer of these materials can be formed by dissolving in an organic solvent accompanying a binder such as polycarbonate, polyacrylate or polyester, and then applying and drying. Organic materials excepting polymer materials can be formed by vacuum evaporation method, too. Film formation methods are not limited to those mentioned above.

The light emitting layer 5 emits blue to blue-green color light by the energy released upon recombination of the holes injected from the anode 2 through the PL light emissive hole injection layer 13 and the hole transport layer 4, and the electrons injected from the cathode 8 through the electron injection layer 7 and the electron transport layer 6. A material of the light emitting layer 5 can be selected from oxazole metal complex, distyryl benzene derivative, styrylamine-containing polycarbonate, oxadiazole derivative, azomethine zinc complex, and aluminum complex.

The light emitting layer 5 can be formed using these materials as a host and, as required, doping a blue fluorescent dye. A variety of light emitting organic substances can be used for doping in the light emitting layer 5. Known examples of such materials include: anthracene, naphthalene, pyrene, tetracene, coronene, perylene, phthaloperylene, naphthaloperylene, diphenyl butadiene, tetraphenyl butadiene, oxadiazole, bisbenzoxazoline, bisstyryl, cyclopentadiene, quinoline metal complex, tris(8-hydroxyquinolinato)aluminum complex, tris(4-methyl-8-hydoxyquinolinato)aluminum complex, tris(5-phenyl-8-hydroxyquinolinato)aluminum complex, aminoquinoline metal complex, benzoquinoline metal complex, tri-(p-terphenyl-4-yl) amine, 1-aryl-2,5-di(2-thienyl)pyrrole derivative, pyran, quinacridone, distyrylbenzene derivative, distyrylarylene derivative and a molecule having a group of one of these light emitting compounds, though not limited to these substances. In addition to the fluorescent dye-derived compounds represented by these compounds, light emitting materials capable of phosphorescence emission from triplet state can be favorably used as well.

Useful materials for electron injection layer 7 and the electron transport layer 6 in the invention can be selected from the materials that can inject and transport electrons and can be readily formed to a thin film. A layer of those materials performs good electron transport effect as to transport electrons smoothly and efficiently into the light emitting layer 5 and prevents holes from moving into the electron transport layer 6. Specific materials include fluorene, bathophenanthroline, bathocuproine, anthraquinodimethane, diphenoquinone, imidazole, anthraquinodimethane and compounds of these substances, metal complex compounds and nitrogen-containing five-membered ring derivatives. Metal complex compounds useful in the invention include tris(8-hydroxyquinolinato)aluminum, tri(2-methyl-8-hydroxyquinolinato)aluminum, tris(8-hydroxyquinolinato)gallium, bis(10-hydroxybenzo[h]quinolinato)beryllium, bis(10-hydroxybenzo[h]quinolinato)zinc, bis(2-methyl-8-hydroxyquinolinato)(o-cresolato)gallium, bis(2-methyl-8-hydroxyquinolinato)(1-naphtholato)aluminum, though not limited to these substances. Nitrogen-containing five-membered ring derivatives useful in the invention include oxazole, thiazole, oxadiazole, thiadiazole and triazole derivatives. Specific compounds of such derivatives include 2,5-bis(1-phenyl)-1,3-oxazole, 2,5-bis(1-phenyl)-1,3-thiazole, 2,5-bis(1-phenyl)-1,3,4-oxadiazole, 2-(4′-t-butylphenyl)-5-(4′-biphenyl)-1,3,4-oxadiazole, 2,5-bis(1-naphtyyl)-1,3,4-oxadiazole, 1,4-bis[2-(5-phenylthiadiazolyl)]benzene, 2,5-bis(1-naphthyl)-1,3,4-triazole, 3-(4-biphenylyl)-4-phenyl-5-(4-t-butylphenyl)-1,2,4-triazole, though not limited to these substances. In addition, polymer materials used in polymer organic electroluminescence devices can be used, too. Such materials include polyparaphenylene and derivatives thereof, and fluorene and derivatives thereof.

In this structure, when the anode 2 is transparent and the cathode 8 is reflective, the EL light emitted from the light emitting layer 5 towards the anode side passes through the PL light emissive hole injection layer 13 and other layers and emitted through the transparent substrate 1. The EL light emitted from the light emitting layer 5 towards the cathode side is reflected on the cathode 8 and again passes through the PL light emissive hole injection layer 13 and other layers and emitted through the transparent substrate 1. In the PL light emissive hole injection layer 13, a part of the EL light receives wavelength distribution conversion and turns to yellow to red PL light. The EL light and the PL light are mixed and produce light emission of the device as a whole in white or light blue color.

On the contrary, when the anode 2 is reflective and the cathode 8 is transparent, the EL light emitted from the light emitting layer 5 towards the anode side passes through the PL light emissive hole injection layer 13 and other layers receiving wavelength distribution conversion. The light is reflected on the anode 2, again passes through the PL light emissive hole injection layer 13, and is emitted through the cathode 8. In the two times of paths through the PL light emissive hole injection layer 13, a part of the EL light receives wavelength distribution conversion and turns to yellow or red PL light. The EL light emitted from the light emitting layer 5 towards the cathode side is emitted through the cathode 8 without receiving wavelength distribution conversion. In this case too, the EL light and the PL light are mixed and the emission from the device as a whole is white or light blue light. In this embodiment, a transparent electrode (anode 2) does not exist in the route from generation of the El light to conversion to the PL light. As a result, the EL light is used for wavelength distribution conversion without scattering towards substrate edge direction due to total reflection on the interface with a transparent electrode. Therefore, white or light blue light can be obtained at high efficiency.

FIG. 2 is a sectional view of an organic EL device of the second embodiment according to the invention. An organic EL device 20 comprises an anode 2, a hole injection layer 3, a hole transport layer 4, a light emitting layer 5, an electron transport layer 6, a PL light emissive electron injection layer 27, and a cathode 8 sequentially laminated on a transparent substrate 1.

The organic EL device 20 of the second embodiment comprises a hole injection layer 3 and a PL light emissive electron injection layer 27 in place of the PL light emissive hole injection layer 13 and the electron injection layer 7, respectively, in the organic EL device 10 of the first embodiment.

The hole injection layer 3 can be formed of a material selected from: p type hydrogenated amorphous silicon, p type hydrogenated amorphous silicon carbide, p type zinc sulfide, and p type zinc selenide; phenylamine polymer compounds such as N,N′-bis(3-methylphenyl)-(1,1′-biphenyl)-4,4′-diamine, N,N-diphenyl-N,N′-(3-methylphenyl)-1,1′-biphenyl-4,4′-diamine, 1,1-bis(4-di-p-tolylaminophenyl) cyclohexane, and 4,4′-bis(N-(1pnaphtyl)-N-phenylamino)biphenyl; hydrazone compounds; silazane compounds; quinacridone compounds; phthalocyanine derivatives (including metal-coordinated complex such as copper phthalocyanine); polyvinyl carbazole; and polysilane. The hole injection layer can be formed by a means known in the art.

One of the host materials useful in the PL light emissive electron injection layer 27 in the invention is Znsq₂, for example.

PL light emitting dye material useful in the PL light emissive electron injection layer 27 can be the same as the PL light emitting dye material doped in the PL light emissive hole injection layer 13 of the first embodiment.

The electron transport layer 6 in this embodiment defines the distance between the carrier recombination layer (light emitting layer) and the carrier nonrecombination layer (PL light emissive electron injection layer 27), and preferably has a thickness at least 15 nm. Material for forming the electron transport layer 6 can be the same as the material for the electron transport layer of the first embodiment.

In the organic EL device 20 of the second embodiment, when the anode 2 is transparent and the cathode 8 is reflective, the EL light emitted from the light emitting layer 5 towards the cathode side passes through the PL light emissive electron injection layer 27 and the other layers, reflected on the cathode 8, passing again through the PL light emissive electron injection layer 27 and other layers, and is emitted through the transparent substrate 1. In the two paths through the PL light emissive electron injection layer 27, a part of the EL light receives wavelength distribution conversion and turns to yellow or red PL light. The EL light emitted from the light emitting layer 5 towards the anode side is emitted through the substrate 1. The EL light and PL light are mixed to give emission in white or light blue color from the device as a whole.

On the contrary, when the anode 2 is reflective and the cathode 8 is transparent, the EL light emitted from the light emitting layer 5 towards the cathode side passes through the PL light emissive electron injection layer 27 and other layers and is emitted through the cathode 8. The EL light emitted from the light emitting layer 5 towards the anode side is reflected on the anode 2, passing through the PL light emissive electron injection layer 27 and other layers, and is emitted from the cathode 8. The both of the EL light towards both directions as described above passes through the PL light emissive electron injection layer 27 and other layers, and partly receives wavelength distribution conversion and turns to yellow or red PL light. The emitting EL light and PL light are mixed to give emission in white or light blue light from the device as a whole. A transparent electrode (anode 2) does not exist in the route from generation of the EL light to conversion to the PL light in this embodiment, too. Consequently, wavelength distribution conversion can be performed at a high efficiency and the white or light blue light can be obtained at high efficiency.

FIG. 3 is a sectional view of an organic EL device of third embodiment according to the invention. An organic EL device 30 comprises an anode 2, a PL light emissive hole injection layer 13, a hole transport layer 4, a light emitting layer 5, an electron transport layer 6, a PL light emissive electron injection layer 27, and a cathode 8 sequentially laminated on a transparent substrate 1. The hole transport layer 4 and the electron transport layer 6 have a thickness of at least 15 nm.

An organic EL device 30 of the third embodiment uses a PL light emissive electron injection layer 27 in place of the electron injection layer 7 in the organic EL device 10 of the first embodiment. The PL light emissive electron injection layer 27 can be formed in the same manner as in the second embodiment. The organic EL device 30 of this embodiment has two carrier nonrecombination layers (PL light emitting layers): the PL light emissive hole injection layer 13 and the PL light emissive electron injection layer 27.

In the organic EL device of the third embodiment, when the anode 2 is transparent and the cathode 8 is reflective, the EL light from the light emitting layer 5 towards the anode side passes through the PL light emissive hole injection layer 13 and other layers and is emitted through the transparent substrate 1. The EL light from the light emitting layer 5 towards the cathode direction passes through the PL light emissive electron injection layer 27 and other layers, reflected on the cathode 8, passing again through the PL light emissive electron injection layer 27, and is emitted through the transparent substrate 1.

On the contrary, when the anode 2 is reflective and the cathode 8 is transparent, the EL light from the light emitting layer 5 towards the anode side passes through the PL light emissive hole injection layer 13 and other layers, reflected on the anode 2, passing again through the PL light emissive hole injection layer 13 and other layers, and is emitted through the cathode 8. The EL light from the light emitting layer 5 towards the cathode side passes through the PL light emissive electron injection layer 27 and other layers, and is emitted through the cathode 8.

In both of the above described cases of this embodiment, a part of the EL light (including the EL light reflected on the cathode) receives wavelength distribution conversion by the PL light emitting dye material in the PL light emissive hole injection layer 13 and becomes first PL light. A part of the EL light converted in the PL light emissive electron injection layer 27 becomes second PL light. The first and second PL light can be in any color from yellow to red. The first and second PL light can be either the same color light or different color light. In a mixture of the emitting EL light, and the first and the second PL light, the device as a whole emits light in white or light blue color. In this embodiment, too, a transparent electrode (anode 2 or cathode 8) does not exist in the route from generation of the EL light to conversion to the PL light. As a result, the wavelength distribution conversion is carried out at high efficiency and white or light blue light can be obtained at a high efficiency. Further in this embodiment, PL light emitting dye material for the PL light emissive hole injection layer 13 and the PL light emitting dye material for the PL light emissive electron injection layer 27 can be selected from different materials in order for the first PL light and the second PL light to have different colors. By this means, such white color light can be obtained that contains enough intensity of wavelength components in the whole range of visible light (for example, white light containing the wavelength components in the blue color range, green color range, and red color range in enough intensity). Such light is favorable for a light source of a display employing color filters without color conversion function.

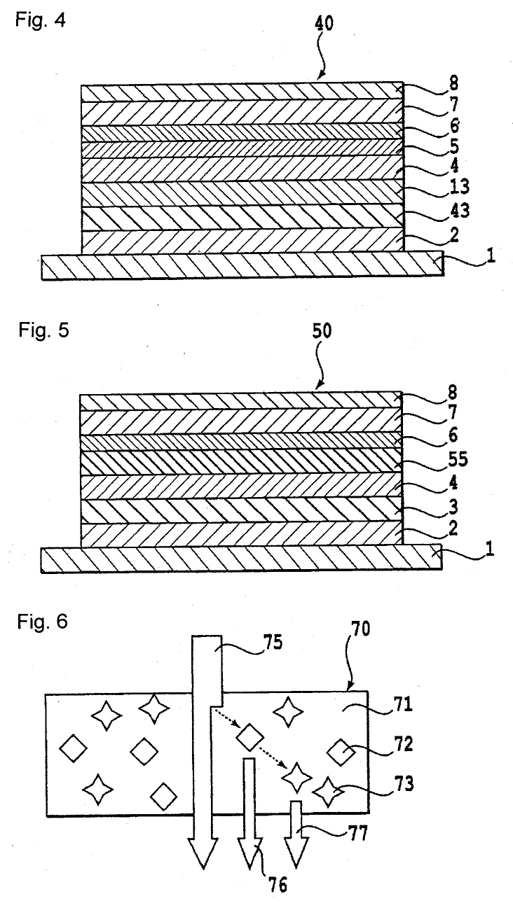

FIG. 4 is a sectional view of an organic EL device of fourth embodiment according to the invention. An organic EL device 40 comprises an anode 2, a non-emissive hole injection layer 43, a PL light emissive hole injection layer 13, a hole transport layer 4, a light emitting layer 5, an electron transport layer 6, an electron injection layer 7, and a cathode 8 sequentially laminated on a transparent substrate 1. Construction elements other than the non-emissive hole injection layer 43 are same as those in the first embodiment.

The non-emissive hole injection layer 43 in this embodiment is composed of a host material and a hole injectivity enhancing agent doped in the host material. The host material can be selected from the materials that can be used in the hole injection layer 3 in the second embodiment.

The hole injectivity enhancing agent enhances hole injection ability and hole transport performance of holes from the anode, to reduce the driving voltage. Useful agents include F₄-TCNQ (2,3,5,6-tetrafluoro-7,7,8,8-tetracyanoquinodimethane), fullerenes (such as C₆₀), FeCl₃, and V₂O₅. The non-emissive hole injection layer 43 contains a hole injectivity enhancing agent in an amount from 1 to 10 wt %, preferably from 2 to 4 wt %. Thickness of the non-emissive hole injection layer 43 is preferably in the range of 20 to 200 nm, preferably 20 to 50 nm.

Although this embodiment has been described referring to an example wherein a non-emissive hole injective hole injection layer 43 is provided in an organic EL device of the first embodiment of the invention, this fourth embodiment can also be applied to an organic EL device of third embodiment in which a non-emissive hole injection layer 43 is interposed between the anode 2 and PL light emissive hole injection layer 13. A non-emissive hole injection layer 43 can be further provided between the PL light emissive hole injection layer 13 and the hole transport layer in first, third, and forth embodiments. In an organic EL device of second embodiment, a non-emissive hole injection layer 43 can be interposed between the anode 2 and the hole injection layer 3, or the non-emissive hole injection layer 43 can be used in place of the hole injection layer 3.

In organic EL devices of the invention as described thus far, a layer that excites and emits light by the energy of carrier recombination of holes/electrons is solely the light emitting layer 5 emitting blue EL light. A part of this blue EL light is absorbed by a host material of a carrier injection layer(s) (which can be a single layer or plural layers) that does not allow carrier recombination. A yellow to red PL light emitting dye material(s) doped in the carrier injection layer(s) converts the blue EL light into yellow to red PL light. In the process of conversion from EL light to PL light, the EL light does not passes through a transparent electrode. As a result, the EL light is not scattered towards substrate edge direction. Therefore, energy efficiency is high.

### EXAMPLES

The present invention will be described in further detail with reference to some specific examples. The invention, however, shall not be limited to the description of the examples. A vacuum evaporation apparatus manufactured by Vieetech Japan, Co., Ltd. was used for depositing organic compounds, metals, and charge generation layers. For controlling deposition speed and thickness of the deposited substance, a deposition monitor CRTM-8000 (manufactured by ULVAC Inc.) using a quartz oscillator was used that is installed in the evaporation apparatus. For measuring an actual thickness after deposition, P10 contact-probe step meter (manufactured by Tencor Corporation) was used. Evaluation of device characteristics was conducted using Source Meter 2400 (manufactured by Keithley Instruments Co., Ltd.) and Topcon BM-8 luminance meter. On the devices manufactured in the following examples, emission brightness, emission efficiency, and maximum emission brightness were measured by applying a dc voltage. EL light emission spectrum was evaluated by driving the device with constant and dc current at the current densities of 4 A/cm², 10 A/cm², and 14 A/cm². The EL spectrum was measured using PMA-11 optical multi channel analyzer (manufactured by Hamamatsu Photonics K.K.).

In the organic materials used for manufacturing the devices of the following examples, fluorescent materials were purchased from Idemitsu Kosan Co., Ltd., and phosphorescent materials were purchased from Showa Denko Co., Ltd. Structural formulas of organic materials commonly used in the examples in the invention are shown in the following.

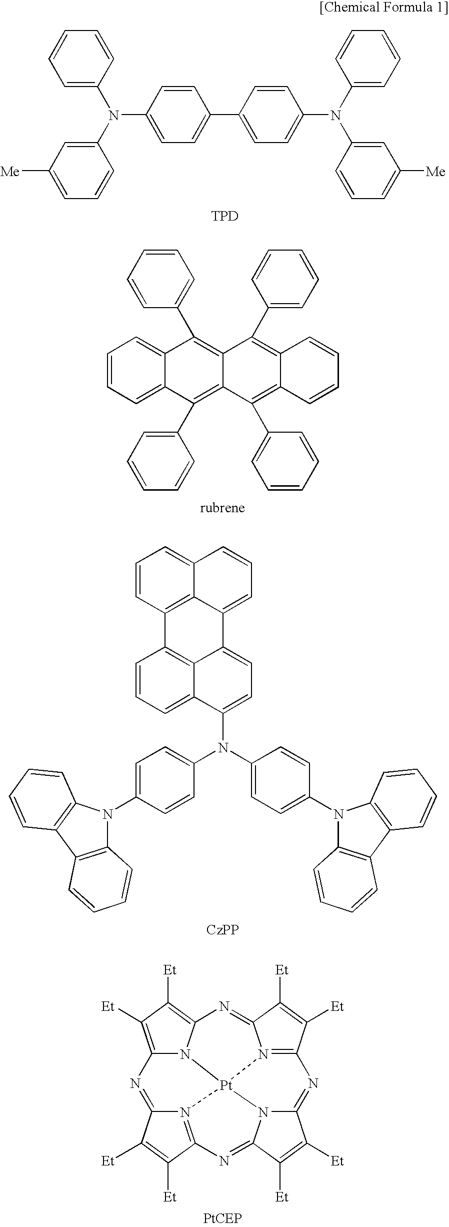

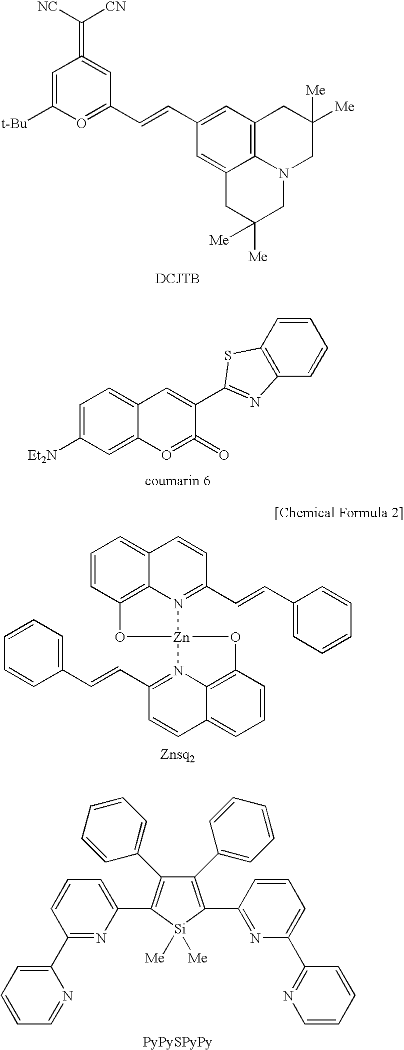

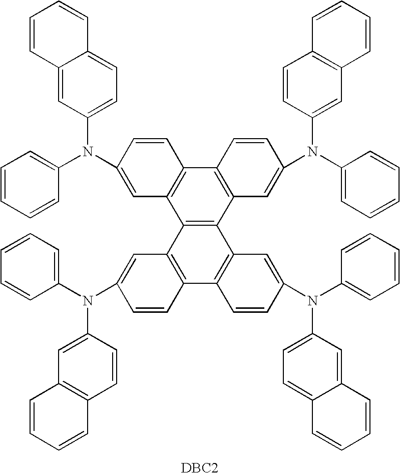

The following describes outline of manufacturing method of organic EL devices of the examples. Unless otherwise described in the description of each example, the organic EL devices of the examples were manufactured according to the outline. An ITO glass (manufactured by Sanyo Vacuum Industries Co., Ltd.) was prepared that had an anode 2 of a transparent electrode with sheet resistance of 7 [symbol] /□ formed by sputtering ITO (indium-tin oxide) on a transparent substrate 1 of glass plate 0.7 mm thick. The ITO glass was ultrasonically cleaned sequentially using acetone, pure water, and isopropyl alcohol for 5 min for every cleaning liquid. After drying, the ITO glass was further cleaned by UV ozone cleaning for 10 min.

The ITO glass was then installed in the vacuum evaporation apparatus evacuated to 1×10⁻⁶ Torr (1.33×10⁻⁴ Pa), and an organic EL layer was deposited at a deposition speed of from 1 to 2 Å/s, a LiF layer 1 nm thick was deposited on the organic EL layer at a deposition speed of 0.25 Å/s, and a cathode 8 was deposited at a deposition speed of 5 Å/s. The LiF layer was a buffer layer for improving electron injection efficiency into the organic EL layer from the cathode 8. The manufactured device was transported, without exposing to the atmospheric air, into a glove box in a dry nitrogen atmosphere with a dew point of below −76° C.

A sealing glass substrate was prepared in the glove box by applying a sealing material of ultraviolet light-setting resin on the periphery of a glass plate and sticking a desiccating agent of barium oxide powder with an adhesive on inner portion of the glass plate. Sealing of the organic EL device was carried out in the glove box by setting the device and the sealing glass together opposing the surface of an organic EL layer of the manufactured EL device to the surface of the sealing material of the sealing glass, and curing the sealing material by irradiating ultraviolet light.

### Example 1

An organic EL device of Example 1 was a device according to first embodiment of the invention. The organic EL device of Example 1 comprised an anode/PL light emissive hole injection layer/hole transport layer/light emitting layer/electron injection-transport layer/buffer layer/cathode, and has a structure of ITO (220 nm)/CzPP: PtOEP [9 wt %] (200 nm)/TPD (15 nm)/DPVBi (30 nm)/Alq₃ (20 nm)/LiF (1 nm)/Al (100 nm).

The PL light emissive hole injection layer was formed by depositing the compounds CzPP and PtOEP at a ratio of deposition speeds of 100:9. Results of evaluation on the obtained organic EL device are given in Table 1 including: maximum brightness, maximum current efficiency, half width (full width at half maximum, FWHM) and chromaticity coordinate of the emitted light in the operation at current densities of 0.4 A/cm² and 1 A/cm², and FWHM and chromaticity coordinate of the emitted light after continuous emission operation for 100 hr at a current density of 1 A/cm². The maximum brightness and maximum current efficiency in this specification mean the highest brightness and the highest current efficiency, respectively, obtained during continuous operation of the device supplying an electric current at a predetermined current density until breakdown of the device.

### Example 2

An organic EL device of Example 2 was a device according to second embodiment of the invention. The organic EL device of Example 2 comprised anode/hole injection-transport layer/light emitting layer/electron transport layer/PL light emissive electron injection layer/buffer layer/cathode, and had a structure of ITO (220 nm)/TPD (40 nm)/DPVBi (30 nm)/BCP (15 nm)/Znsq₂: rubrene [8 wt %] (80 nm)/LiF (1 nm)/Al (100 nm).

The PL light emissive electron injection layer was formed by depositing the compounds Znsq₂ and rubrene at a ratio of deposition speeds of 100:8. Results of evaluation on the obtained organic EL device are given in Table 1.

### Example 3

An organic EL device of Example 3 was a device according to third embodiment of the invention. The organic EL device of Example 3 comprised anode/PL light emissive hole injection layer/hole transport layer/light emitting layer/electron transport layer/PL light emissive electron injection layer/buffer layer/cathode, and had a structure of ITO (220 nm)/CzPP: PtOEP [9 wt %] (100 nm)/TPD (15 nm)/DPVBi (30 nm)/Alq₃ (20 nm)/BCP (15 nm)/PyPySPyPy:rubrene [8 wt %] (40 nm)/LiF (1 nm)/Al (100 nm).

The PL light emissive hole injection layer was formed by depositing the compounds CzPP and PtOEP at a ratio of deposition speeds of 100:9. The PL emissive electron injection layer was formed by depositing the compounds PyPySPyPy and rubrene at a ratio of speeds of 100:8. Results of evaluation on the obtained organic EL device are given in Table 1.

### Example 4

An organic EL device of Example 4 was a device according to first embodiment of the invention that includes two PL light emissive carrier nonrecombination layers. The organic EL device of Example 4 comprised anode/first PL light emissive hole injection layer/second PL light emissive hole injection layer/hole transport layer/light emitting layer/electron injection-transport layer/buffer layer/cathode, and had a structure of ITO (220 nm)/CzPP:DCTJB [2 wt %] (20 nm)/DBC2:coumarin 6 [2 wt %] (80 nm)/TPD (15 nm)/DPVBi (30 nm)/PyPySPyPy (20 nm)/LiF (1 nm)/Al (100 nm).

The first PL light emissive hole injection layer was a hole injection layer doped with a red dye DCTJB and formed by depositing the compounds CzPP and PtOEP at a ratio of deposition speeds of 100:2. The second PL light emissive hole injection layer was a hole injection layer doped with a green dye of coumarin 6 and formed by depositing the compounds DBC2 and coumarin 6 at a ratio of deposition speeds of 100:2. Results of evaluation on the obtained organic EL device are given in Table 1.

### Example 5

An organic EL device of Example 5 was a device according to fourth embodiment of the invention. The organic EL device of Example 5 comprised anode/non-emissive hole injection layer/PL light emissive hole injection layer/hole transport layer/light emitting layer/electron transport layer/PL light emissive electron injection layer/buffer layer/cathode, and had a structure of ITO (220 nm)/CzPP:F₄-TCNQ [3 wt %] (40 nm)/CzPP:PtOEP [9 wt %] (200 nm)/TPD (15 nm)/DPVBi (30 nm)/Alq₃ (20 nm)/LiF (1 nm)/Al (100 nm).

The PL light emissive hole injection layer was formed by depositing the compounds CzPP and PtOEP at a ratio of deposition speeds of 100:9. The non-emissive hole injection layer was formed by depositing the compounds CzPP and F₄-TCNQ at a ratio of deposition speeds of 100:3. Results of evaluation on the obtained organic EL device are given in Table 1.

### Comparative Example 1

An organic EL device of Comparative Example 1 was a device according to a prior art shown in FIG. 5 in which white light is obtained using a light emitting layer 55 doped with a dye material. The organic EL device of Comparative Example 1 comprised anode/hole injection-transport layer/light emitting layer/electron injection-transport layer/buffer layer/cathode, and had a structure of ITO (220 nm)/TPD (200 nm)/DPVBi:rubrene [0.3 wt %] (30 nm)/Alq₃ (20 nm)/LiF (1 nm)/Al (100 nm).

The light emitting layer 55 doped with a dye material was formed by depositing the compounds DPVBi and rubrene at a ratio of deposition speeds of 1000:3. Results of evaluation on the obtained organic EL device are given in Table 1.

### Comparative Example 2

The device of Comparative Example 2 was an organic EL device having a structure of a prior art without a carrier nonrecombination layer containing a PL light emitting dye material. The organic EL device of Comparative Example 2 comprised anode/hole injection-transport layer/light emitting layer/electron injection-transport layer/buffer layer/cathode, and had a structure of ITO (220 nm)/TPD (200 nm)/DPVBi (30 nm) Alq₃ (20 nm)/LiF (1 nm)/Al (100 nm). Results of evaluation on the obtained organic EL device are given in Table 1.

TABLE 1
Characteristics of Devices of Examples and Comparative Examples

| | | Example | | | | | Comp. Example | |
|---|---|---|---|---|---|---|---|---|
| | | 1 | 2 | 3 | 4 | 5 | 1 | 2 |
| maximum | | 22,300 | 19,342 | 22,308 | 18,960 | 23,048 | 18,030 | 25,000 |
| brightness | | | | | | | | |
| (Cd/m²) | | | | | | | | |
| maximum current | | 5.8 | 5.4 | 5.8 | 5.2 | 6.1 | 1.2 | 2.3 |
| efficiency (Cd/A) | | | | | | | | |
| DC driving | FWHM | 188 | 186 | 218 | 234 | 205 | 195 | 132 |
| (at 0.4 A/cm²) | chromaticity | 0.32 | 0.34 | 0.33 | 0.32 | 0.33 | 0.32 | 0.19 |
| | coordinate x | | | | | | | |
| | chromaticity | 0.33 | 0.30 | 0.32 | 0.35 | 0.32 | 0.36 | 0.38 |
| | coordinate y | | | | | | | |
| DC driving | FWHM | 187 | 188 | 217 | 230 | 205 | 175 | — |
| (at 1 A/cm²) | chromaticity | 0.32 | 0.33 | 0.33 | 0.33 | 0.33 | 0.30 | — |
| | coordinate x | | | | | | | |
| | chromaticity | 0.34 | 0.31 | 0.33 | 0.34 | 0.34 | 0.40 | — |
| | coordinate y | | | | | | | |
| DC driving | FWHM | 188 | 188 | 218 | 230 | 205 | 176 | — |
| (after 100 h) | chromaticity | 0.32 | 0.33 | 0.33 | 0.33 | 0.33 | 0.30 | — |
| (at 1 A/cm²) | coordinate x | | | | | | | |
| | chromaticity | 0.34 | 0.31 | 0.33 | 0.34 | 0.33 | 0.40 | — |
| | coordinate y | | | | | | | |

It has been confirmed as apparent from Table 1 that the change of emitted color depending on magnitude of the driving current is slight in white EL devices having structures of Examples as compared with the devices of Comparative Examples. Moreover, it has been clarified that the emitted color does not change in the white EL devices having structures of Examples even after continuous DC light emission operation for 100 hr.

1. An organic EL device comprising an organic EL layer sandwiched by a pair of electrodes, the organic EL layer including at least a carrier recombination layer and one or more carrier nonrecombination layers; wherein the carrier recombination layer emits EL light in blue to blue-green color having a peak wavelength of from 400 to 500 nm through recombination of the carriers injected into the organic EL device; the carrier nonrecombination layer has carrier injection/transport property and contains a host material that absorbs at least a part of the EL light and one or more types of PL light emitting dye material that emits PL light with lower energy than that of the EL light; and a distance between the carrier recombination layer and the carrier nonrecombination layer is at least 15 nm.

2. The organic EL device according to claim 1, wherein the carrier nonrecombination layer is selected from the group consisting of a hole injection layer, an electron injection layer, and a hole injection-transport layer.

3. The organic EL device according to claim 1, wherein the organic EL device emits a part of the EL light not absorbed by the host material and the PL light.

4. The organic EL device according to claim 3, wherein the organic EL device emits white light.

5. The organic EL device according to claim 1, wherein the PL light is yellow light or red light.

6. The organic EL device according to claim 1, wherein the PL light emitting dye material is one type of material.

7. The organic EL device according to claim 1, wherein the pair of electrodes is an anode and a cathode, and the organic EL layer further includes a non-emissive hole injection layer that is in contact with the anode and contains a hole injectivity enhancing agent.

8. The organic EL device according to claim 1, wherein the pair of electrodes is an anode and a cathode, and the cathode is made of a material having a work function not larger than 4.3 eV and a light reflectivity of at least 90%.

9. The organic EL device claim 1, wherein the pair of electrodes is an anode and a cathode, and the anode has a light reflectivity of at least 80% and the cathode is formed of a transparent conductive material.
